(19) United States
(12) Patent Application Publication
(10) Pub. No.: US 2026/0057437 A1
(43) Pub. Date: Feb. 26, 2026

(54) SYSTEMS AND METHODS FOR PROVIDING A BUY NOW, PAY LATER OFFER WITH OPEN BANKING

(71) Applicant: Mastercard International Incorporated, Purchase, NY (US)

(72) Inventors: Sivaramakrishnan Hariharan, Pune (IN); Bhaumit Harde, Mehsana (IN); Parag Prabhakar Mungale, St. Albans (GB); Ravi Sapariya, Junagadh (IN); Yogesh Chopade, Pune (IN)

(73) Assignee: Mastercard International Incorporated, Purchase, NY (US)

(21) Appl. No.: 18/814,735

(22) Filed: Aug. 26, 2024

(51) Int. Cl. G06Q 40/03; G06Q 20/34; G06Q 40/02

(52) U.S. Cl. CPC G06Q 40/03; G06Q 20/348; G06Q 20/351; G06Q 40/02

(57) ABSTRACT

Methods and systems for leveraging open banking to include installment payment offerings include receiving a request message for an installment loan offer. The request message is associated with a transaction being performed by a consumer. The request message includes account access credentials associated with an open banking installment offer service account and transaction details associated with the transaction. The account access credentials are validated and the open banking installment offer service account is accessed. One or more installment loan offers are retrieved based on consumer preferences associated with the open banking installment offer service account. The installment loan offers are transmitted to the computer associated with the merchant. A consent message including consumer consent information indicating consent to share open banking data with one or more installment program providers (IPPs) is received. The open banking data is associated with the consumer.

### BACKGROUND

The present invention relates generally to installment loans and, more particularly, to leveraging open banking infrastructure to provide a streamlined Buy Now, Pay Later installment loan process to a consumer.

Installment loans, or Buy Now, Pay Later (BNPL) loans, have gained significant popularity in recent years as an alternative payment method for consumers. The concept behind BNPL is relatively simple: it allows customers to make a purchase and defer the payment over a specified period, typically in multiple installments. Instead of paying the full price upfront, consumers can split their payments into more manageable chunks, often with little to no interest if the installments are paid on time. Because more installment program providers (IPPs) and merchants are participating in offering BNPL products, with the numbers of participants only increasing, it is difficult for IPPs to satisfy Know Your Customer (KYC) requirements and open new installment accounts for consumers.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system is provided. The system includes a database storing one or more installment loan offers and an open banking installment offer service account. The open banking installment offer service account is associated with account access credentials, open banking data associated with a consumer, and consumer preferences. The system also includes one or more processors coupled in communication to the database. Furthermore, the system includes a memory device storing computer-executable instructions thereon. The computer-executable instructions cause the one or more processors to receive, from a computer associated with a merchant, a request message for one or more installment loan offers. The request message is associated with a transaction being performed by the consumer. The request message includes the account access credentials and transaction details associated with the transaction. The transaction details include the transaction amount. The instructions further cause the one or more processors to validate the account access credentials and access the open banking installment offer service account using the account access credentials. Moreover, the instructions cause the one or more processors to retrieve, from the database, the one or more installment loan offers based on the consumer preferences and transmit the one or more installment loan offers to the computer associated with the merchant. Additionally, the instructions cause the one or more processors to receive a consent message including consumer consent information indicating consent to share the open banking data with one or more installment program providers (IPPs).

In another aspect, a computer-implemented method is provided. The method includes receiving, from a computer associated with a merchant, a request message for one or more installment loan offers. The request message is associated with a transaction being performed by the consumer. The request message includes account access credentials associated with an open banking installment offer service account and transaction details associated with the transaction. The transaction details include a transaction amount. The method includes validating the account access credentials and accessing the open banking installment offer service account using the account access credentials. Furthermore, the method includes retrieving, from a database, the one or more installment loan offers based on consumer preferences associated with the open banking installment offer service account. The method also includes transmitting the one or more installment loan offers to the computer associated with the merchant and receiving a consent message including consumer consent information indicating consent to share open banking data with one or more installment program providers (IPPs). The open banking data is associated with the consumer.

In another embodiment, a non-transitory computer-readable storage medium is provided. The medium has computer-executable instructions stored thereon. The computer-executable instructions, when executed by one or more processors, cause the one or more processors to receive, from a computer associated with a merchant, a request message for one or more installment loan offers. The request message is associated with a transaction being performed by the consumer. The request message includes account access credentials associated with an open banking installment offer service account and transaction details associated with the transaction. The transaction details include a transaction amount. The instructions also cause the one or more processors to validate the account access credentials and access the open banking installment offer service account using the account access credentials. Furthermore, the instructions cause the one or more processors to retrieve, from a database, the one or more installment loan offers based on consumer preferences associated with the open banking installment offer service account and transmit the one or more installment loan offers to the computer associated with the merchant. Moreover, the instructions cause the one or more processors to receive a consent message including consumer consent information indicating consent to share open banking data with one or more installment program providers (IPPs). The open banking data is associated with the consumer.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an exemplary system for providing one or more Buy Now, Pay Later (BNPL) financing products to a consumer via open banking, in accordance with an aspect of the present invention;

FIG. 2 is an example configuration of a user computing system for use with the system shown in FIG. 1;

FIG. 3 is an example configuration of a server system for use with the system shown in FIG. 1;

FIG. 4 is an example configuration of an open banking installment offer system for use with the system shown in FIG. 1;

FIG. 5 is a flowchart illustrating an exemplary computer-implemented method for registering a consumer for an open banking installment offer service, in accordance with one embodiment of the present disclosure;

FIGS. 6A and 6B depict a flowchart illustrating an exemplary computer-implemented method for completing a transaction with an open banking Buy Now, Pay Later (BNPL) installment offer made available to a consumer, according to one aspect of the present invention;

FIG. 7 is a block diagram of an exemplary system for providing one or more Buy Now, Pay Later (BNPL) financing products to a consumer via open banking, in accordance with another aspect of the present invention; and

FIGS. 8A and 8B depict a flowchart illustrating an exemplary computer-implemented method for completing a transaction with an open banking Buy Now, Pay Later (BNPL) installment offer made available to a consumer, according to another aspect of the present invention.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N. Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

### Exemplary System

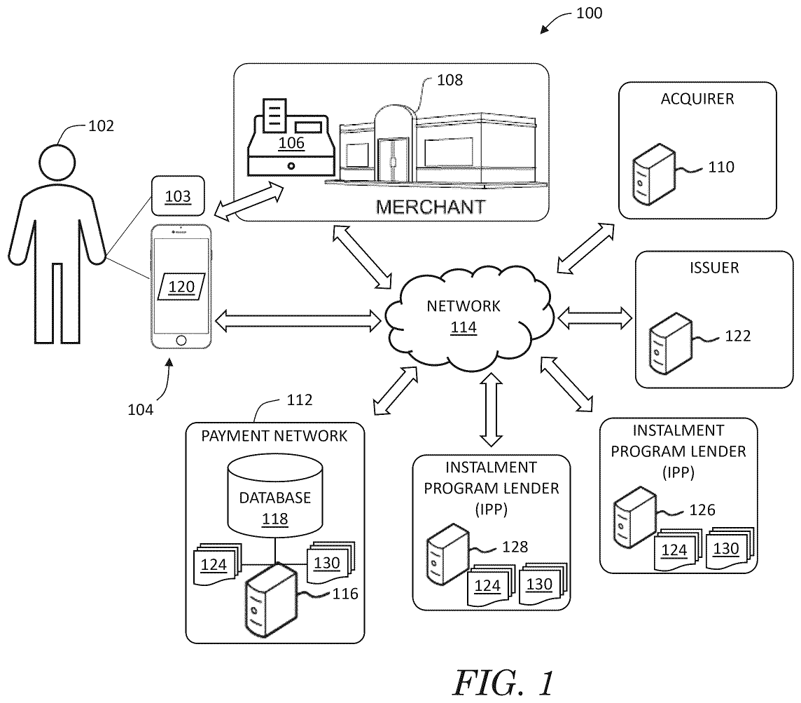

FIG. 1 is a block diagram of an exemplary system 100 for providing one or more Buy Now, Pay Later (BNPL) financing products (e.g., BNPL installment loans) to a consumer 102 via open banking, in accordance with an aspect of the present invention. In the example, the consumer 102 may have access to consumer computing device 104 through which the consumer 102 may request installment payments (e.g., via BNPL financing) for a purchase transaction being performed by the consumer 102.

In the example embodiment, the open banking installment offer system 100 may generally include a merchant 108 having a merchant computer 106 (e.g., a smart point-of-interaction (POI) system or other computing system), a merchant acquirer and its associated computer 110 (the reference character 110 may be used herein in association with the acquirer and/or the acquirer computer), a payment network 112, one or more installment program providers (IPPs) and associated computers 126, 128 (the reference characters 126, 128 may be used herein in association with the IPPs and/or the IPP computers), and an issuer and its associated computer 122 (the reference character 122 may be used herein in association with the issuer and/or the issuer computer).

The merchant computer 106 may be a data processing device associated with a merchant, such as the merchant 108. In some embodiments, the merchant computer may include a merchant checkout user interface (UI) displayed on a display of the consumer computing device 104 or other data processing device.

The merchant computer 106, the merchant acquirer computer 110, the payment network 112, the IPP computers 126, 128, and the issuer 122 may be coupled in communication via a communications network 114. The network 114 may include, for example and without limitation, one or more of a local area network (LAN), a wide area network (WAN) (e.g., the Internet, etc.), a mobile network, a virtual network, and/or any other suitable public and/or private network capable of facilitating communication among the merchant computer 106, the acquirer computer 110, the payment network 112, the IPP computers 126, 128, and/or the issuer 122. In some embodiments, the network 114 may include more than one type of network, such as a private payment transaction network provided by the payment network 112 to the acquirer computer 110, the IPP computers 126, 128, and the issuer 122, and, separately, the public Internet, which may facilitate communication between the merchant 108, the payment network computer 112, the acquirer computer 110, the IPP computers 126, 128, the issuer 122, and the consumer 102, etc.

Embodiments described herein may relate to a payment card system, such as a credit card payment system using the Mastercard® interchange network. (Mastercard is a registered trademark of Mastercard International Incorporated). The Mastercard interchange network is a set of proprietary communications standards promulgated by Mastercard for the exchange of financial transaction data and the settlement of funds between financial institutions that are members of the Mastercard interchange network.

In a typical payment card system, a financial institution called the “issuer,” such as the issuer 122, may issue a financial account and an associated payment card, such as a payment card 103, to a consumer, such as the consumer 102. The consumer 102 may use the financial account or payment card 103 to tender payment for a purchase from the merchant 108. Alternatively, the consumer 102 may purchase a good or service from the merchant 108 using an installment loan (also referred to herein as a Buy Now, Pay Later installment loan (BNPL installment loan)) option provided to the consumer 102, for example, at the merchant computer 106 from one or more IPPs, such as the IPPs 126, 128. The merchant 108 typically may be associated with products, such as goods and/or services, that may be offered for sale and may be sold to the consumer 102. The merchant 108 may include, for example, a physical location and/or a virtual location. A physical location may include, for example, a brick-and-mortar store, etc., and a virtual location may include, for example, an Internet-based storefront.

In the exemplary embodiment, to accept payment with the BNPL installment loan option, which may be associated with a virtual payment credential or payment account, the merchant 108 must normally establish an account with a financial institution that is part of the system 100. This financial institution is usually called the “merchant bank,” the “acquiring bank,” or an “acquirer,” and may operate an acquirer computer 110. When the consumer presents payment for a purchase with, for example, the BNPL installment loan option (e.g., a virtual payment credential issued by or a payment account number provided by one of the IPP computers 126, 128), the merchant 108 may request authorization from the acquirer computer 110 for the amount of the purchase. Typically, the request is performed using the merchant computer 106.

The merchant computer 106 may communicate electronically with one or more transaction processing computers of the acquirer, such as the acquirer computer 110, to transmit the account information associated with the virtual payment credential or payment account details thereto. Alternatively, the acquirer may authorize a third party to perform transaction processing on its behalf. In this case, the merchant computer 106 will be configured to communicate with the third party. Such a third party is usually called a “merchant processor,” an “acquiring processor,” or a “third party processor.” In some embodiments, the merchant computer 106 may include a merchant checkout user interface (UI) displayed on the consumer computing device 104 or other data processing device.

Using the payment network 112, computers of the acquirer 110 and/or merchant processor may communicate with computers of the IPPs 126 or 128 to determine whether the virtual payment credential account or payment account is in good standing and whether the purchase is covered by the available credit line. Based on these determinations, the request for authorization may be declined or accepted. If the request is accepted, an authorization code may be issued to the merchant 108.

When a request for authorization is accepted, the available credit line of the virtual payment credential account or payment account may be decreased. After the merchant 108 ships or delivers the goods or services, the merchant 108 may capture the transaction by, for example, appropriate data entry procedures on the merchant computer. This may include bundling of approved transactions daily for standard retail purchases. If the consumer(s) cancels the transaction before it is captured, a “void” may be generated. If the consumer(s) returns the goods after the transaction has been captured, a “credit” may be generated. The payment network 112 may store the transaction information, such as, and without limitation, a type of merchant, a merchant identifier, a location where the transaction was completed, an amount of purchase, and a date and time of the transaction, in a transaction database, such as the transaction database 118.

After a purchase has been made, a clearing process may occur to transfer additional transaction data related to the purchase among the parties to the transaction, such as the acquirer computer 110, the payment network 112, and the IPP computer 126 or 128. More specifically, during and/or after the clearing process, additional data, such as a time of purchase, a merchant name, a type of merchant, purchase information, user account information, a type of transaction, itinerary information, information regarding the purchased item and/or service, and/or other suitable information, may be associated with a transaction and transmitted between parties to the transaction as transaction data, and may be stored by any of the parties to the transaction.

After a transaction is authorized and cleared, the transaction may be settled among the merchant 108, the acquirer 110, and the IPPs 126, 128. Settlement refers to the transfer of financial data or funds among the merchant 108, the acquirer computer 110, and the IPP computer 126 or 128 related to the transaction. Usually, transactions may be captured and accumulated into a “batch,” which may be settled as a group. More specifically, a transaction typically may be settled between the IPP computer 126 or 128 and the payment network 112, and then between the payment network 112 and the acquirer computer 110, and then between the acquirer computer 110 and the merchant 108.

Normally, an interchange fee may be paid by the acquirer to the issuer (such as the IPP) with respect to a particular transaction. These fees are typically expressed as a percentage of the transaction value, plus a flat fee per transaction. The purpose of the interchange fee is to compensate the issuer for a portion of the risks and costs it incurs. For example, the interchange fee helps to cover the costs associated with processing the transaction, such as fraud prevention and data processing.

In the example, the payment network 112 includes an open banking installment offer system 116. The open banking installment offer system 116 may be configured to receive transaction data, financial account information, a credit rating or credit score, personal information, and/or location data associated with a consumer, such as the consumer 102. The transaction data may include, for example, a large sample of initial and/or historical transaction data. The financial account information may include a bank identification number (BIN) associated with the consumer's financial account or payment card 103. The BIN may allow the open banking installment offer system 116 to identify BNPL installment offers offered by BNPL providers (such as the IPPs 126, 128) and/or merchants (such as the merchant 108) that may be associated with a specific BIN or BIN range. The personal information may include, for example, contact information (e.g., name, phone number, email address, etc.), demographic information (e.g., age, gender, marital status, income, education, employment, etc.), and the like. The credit rating or credit score may be associated with the consumer 102 identified by the personal information. Additionally, the location information may include location data identifying a physical or geographic location of the consumer computing device 104, which may generally be associated with the consumer 102.

The open banking installment offer system 116 may also be configured to store lending preferences of a consumer, such as the consumer 102. The lending preferences may include, for example, one or more consumer preferred IPPs and/or loan preferences (e.g., loan length, APR, etc.). Loan preferences may include, for example, a loan length, an APR, etc.

The open banking installment offer system 116 may also be configured to receive product data and BNPL installment loan offers from IPPs, such as the IPPs 126, 128. For example, a BNPL installment loan offer or program may include a credit amount, a credit limit or value, an associated duration or installment period, an annual percentage rate (APR), a product SKU (shop-keeping unit) or SKUs associated with the BNPL installment loan offer, a date range specifying when the BNPL installment loan offer is valid, payment card BIN or BIN ranges, restrictions, and the like.

The open banking installment offer system 116 may also be configured to receive product data and available BNPL installment offers from merchants, such as the merchant 108. For example, the merchant 108 may provide a product SKU or SKUs associated with any BNPL installment loan offers that the merchant 108 may offer to its customers, such as the consumer 102. For example, the merchant 108 may have a working relationship with one or more IPPs, such as the IPPs 126, 128, and may select to offer one or more BNPL installment loans from the IPPs 126, 128 to its customers.

### Exemplary Computer Systems

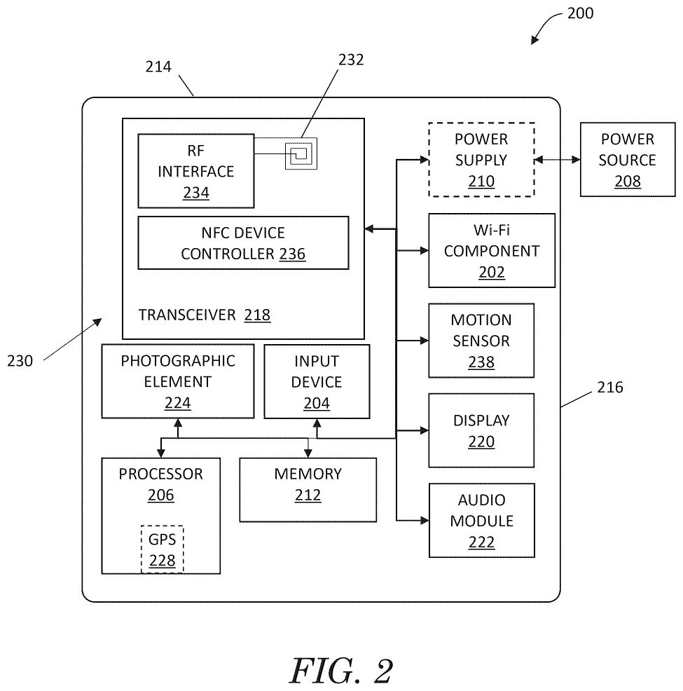

FIG. 2 is an example configuration of a user computing system 200, such as the consumer computing device 104 (shown in FIG. 1) that may be operated by a user, such as the consumer 102 (shown in FIG. 1). In the exemplary embodiment, the computing system 200 may be a computing device configured to connect wirelessly to one or more of the merchant 108, the IPPs 126, 128, the network 114, and any other computing devices associated with the system 100.

In the exemplary embodiment, the computing system 200 may generally include a processor 206, a memory device 212, a transceiver 218 (or a wireless communication device), and a photographic element 224. In addition, the computing system 200 may include an integrated Wi-Fi component 202 (e.g., implementing the Institute of Electrical and Electronics/IEEE 802.11 family of standards), an input device 204, a display 220, and an audio module 222. Moreover, the computing system 200 optionally may include an internal power supply 210 (e.g., a battery or other self-contained power source) to receive power, or alternatively, in some embodiments, the computing system 200 may include an external power source 208. Optionally, the computing system 200 may include a motion sensor 238.

The processor 206 may include one or more processing units (e.g., in a multi-core configuration) specially programmed for executing computer readable instructions. The instructions may be executed within a variety of different operating systems (OS) on the computing system 200, such as UNIX, LINUX, Microsoft Windows®, etc. More specifically, the instructions may cause various data manipulations on data stored in the memory device 212 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C #, C++, Java, or other suitable programming languages, etc.). The memory device 212 may be any device allowing information such as payment card data, the executable instructions, and/or other data to be stored and retrieved. The memory device 212 may include one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 200 may be widely deployed, it may be impractical to manually update software for each computing system 200. Therefore, the system 100 may provide a mechanism for automatically updating the software on the computing system 200. For example, an updating mechanism may be used to automatically update any number of components and their drivers, both network and non-network components, including system level (OS) software components. In some embodiments, the components of the computing system 200 may be dynamically loadable and unloadable; thus, they may be replaced in operation without having to reboot the OS.

A location of the computing system 200 may be obtained through conventional methods, such as a location service (e.g., global positioning system (GPS) service) in the computing system 200, “ping” data that includes geotemporal data, from cell location register information held by a telecommunications provider to which the computing system 200 may be connected, and the like. For example, in one suitable embodiment, a GPS chip 228 may be part of or separate from the processor 206 to enable the location (or geolocation) of the computing system 200 to be determined.

The Wi-Fi component 202 (broadly, a communication interface) may be communicatively connectable to a remote component, such as the network 114 and/or a remote device such as the merchant computer 106. The Wi-Fi component 202 may include, for example, a wireless or wired network adapter or a wireless data transceiver for use with Wi-Fi (e.g., implementing the Institute of Electrical and Electronics/IEEE 802.11 family of standards), Bluetooth communication, radio frequency (RF) communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 212 may be, for example, computer readable instructions for providing a user interface to the user, such as the consumer 102, via the display 220 and, optionally, receiving and processing input from the input device 204. A user interface may include, among other possibilities, a web browser, a client application, a digital wallet, and the like. Web browsers may enable users, such as the consumer 102, to view and interact with media and other information typically embedded on a web page or a website. A client application, such as a financial application 120 (shown in FIG. 1), may allow the consumer 102 to interact with a server application, for example, associated with the open banking installment offer system 116 and/or any other computing system associated with the system 100. The financial application may include a digital wallet. A digital wallet may allow the consumer 102, to receive, generate, and/or store payment credentials, such as tokens associated with the payment card 103, the virtual payment credential, and/or a payment account.

The photographic element 224 may include a camera or other optical sensor and lens combination capable of generating a video signal and capturing an image, iris scan, and the like. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212.

In some embodiments, the motion sensor 238 may include one or more sensor elements that facilitate detecting a person's presence. For example, the motion sensor 238 may detect when the consumer 102 moves or raises the user consumer system 200. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the consumer's presence may be detected by detecting motion using the photographic element 224. The motion sensor 238 may include, for example, and without limitation, sensor elements such as a passive infrared sensor, an ambient light sensor, and the like.

In the example embodiment, the display 220 may include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect the presence of the consumer 102, for example, by detecting that the consumer 102 has touched the display 220 of the computing system 200.

The audio module 222 may include, for example, and without limitation, a speaker and related components capable of broadcasting streaming and/or recorded audio and may also include a microphone. The microphone facilitates capturing audio through the computing system 200.

In the example embodiment, the computing system 200 includes the housing 214 at least partly (and more preferably, at least substantially or entirely) enclosing the components described above. In addition, the computing system 200 includes circuitry 230 configured to communicate with the network 114 (shown in FIG. 1) and/or other computing devices (e.g., other mobile devices, the computers or systems 106, 110, 112, 116, 122, 126, and 128, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the computing system 200. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 may be fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 may be fabricated from any material that enables the computing system 200 to function as described herein, such as metals, etc.

In one embodiment, the transceiver 218 may include an antenna 232. The antenna 232 includes a looped wire configured to transmit radio signals when current flows through the looped wire. The antenna 232 is any size, shape, and configuration that is suitable for transmitting signals as described herein. For example, the antenna 232 may be a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 may be configured to vibrate at a frequency of about 13.56 MHz, which is suitable for use in a near field communication (NFC) system.

In the example embodiment, the antenna 232 may transmit radio signals to and may receive radio signals from other wireless-enabled computing devices, for example, another mobile device, the computers or systems 106, 110, 112, 116, 122, 126, and 128, and/or any other components used in wireless systems. In NFC systems, for example, at least one NFC component generates a magnetic field to inductively transfer currents and, thereby, exchange signals and information with other NFC components positioned within the magnetic field. In one example embodiment, the antenna 232 may function as an NFC component to send and receive signals. The antenna 232 may be configured to transmit radio signals to NFC components positioned within the magnetic field of the antenna 232, such as when the computing system 200 is positioned within a predetermined distance of the merchant computer 106. Therefore, the magnetic field generated by the antenna 232 may define the active range of the computing system 200. Additionally, the antenna 232 may receive radio signals from NFC components when the antenna 232 is positioned within the magnetic field of the NFC components.

The transceiver 218 also may include a radio frequency (RF) interface 234 and an NFC device controller 236. The RF interface 234 and the NFC device controller 236 may be powered by the power source 208, and in some embodiments, the internal power supply 210 and/or the display 220. In addition, the processor 206 and the memory device 212 may be powered in the same manner. The RF interface 234 may be configured to receive and transmit RF signals through the antenna 232. The NFC device controller 236 may be configured to process the received RF signals and to generate signals to be transmitted by the RF interface 234. The memory device 212 may be configured to store data associated with transmitting and receiving the RF signals. The NFC device controller 236 may be coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

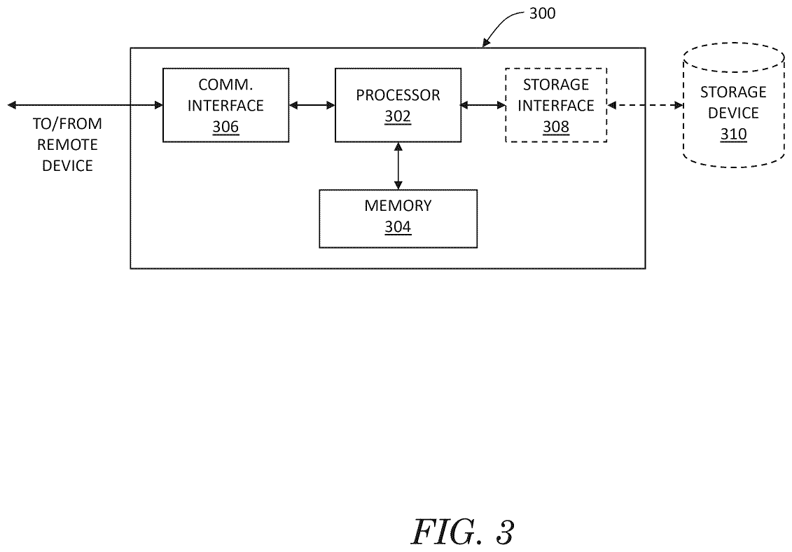

FIG. 3 is an example configuration of a server system 300. In an embodiment, the server system 300 may include, but not be limited to, the merchant computer 106, the acquirer computer 110, the IPP computers 126, 128, and/or the issuer computer 122 (all shown in FIG. 1). In the example embodiment, the server system 300 may include a processor 302 for executing instructions. The instructions may be stored in a memory 304, for example. The processor 302 may include one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C #, C++, Java, or other suitable programming languages, etc.).

The processor 302 may be operatively coupled to a communication interface 306 such that the server system 300 can communicate with a remote device such as a user computing system 200 (shown in FIG. 2), one or more of the computers or systems 104, 106, 110, 112, 116, 122, 126, and 128, and/or another server system. For example, the communication interface 306 may receive communications from a consumer computing device 104 via the Internet (FIG. 1).

The processor 302 may be operatively coupled to the storage device 310. The storage device 310 may be any computer-operated hardware suitable for storing and/or retrieving data. In some embodiments, the storage device 310 may be integrated in the server system 300. In other embodiments, the storage device 310 may be external to the server system 300. The storage device may be similar to the database 118 (shown in FIG. 1). For example, the server system 300 may include one or more hard disk drives as the storage device 310. In other embodiments, the storage device 310 may be external to the server system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 may be operatively coupled to the storage device 310 via a storage interface 308. The storage interface 308 may be any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

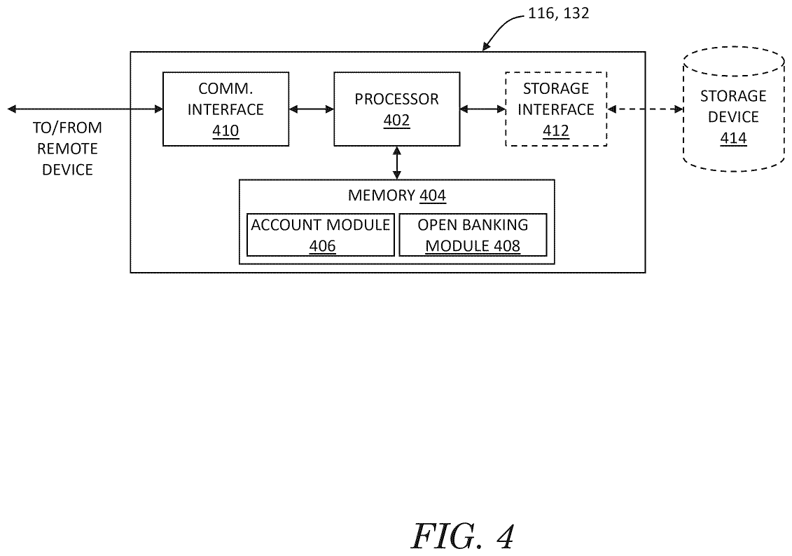

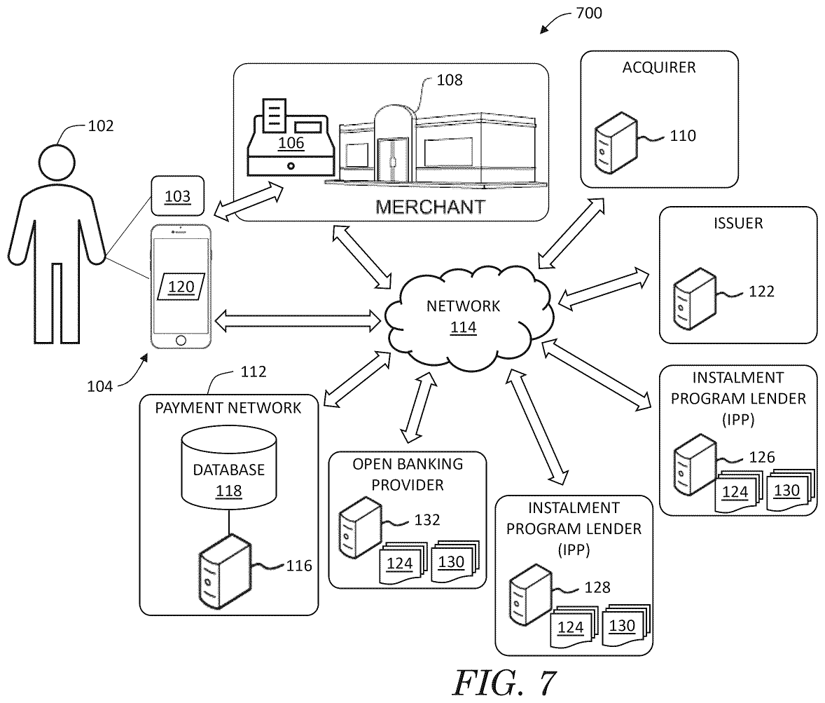

FIG. 4 is an example configuration of the open banking installment offer system 116 and an open banking provider computer 132 (shown in FIG. 7). The description below will use open banking installment offer system 116, but it is understood that the description is equally applicable to the open banking provider computer 132. In the example embodiment, the open banking installment offer system 116 may include a processor 402 for executing instructions. The instructions may be stored in a memory 404, for example. In an embodiment, one or more processes executed by the open banking installment offer system 116 may be implemented in the form of programming instructions of one or more software modules, components, or engines, such as an account module 406 and an open banking module 408, stored on the memory 404. However, it will be apparent that the processes could alternatively be implemented, either in part or in their entirety, in the form of one or more dedicated hardware components, such as application-specific integrated circuits (ASICs), and/or in the form of configuration data for configurable hardware components, such as field programmable gate arrays (FPGAs), for example.

In the example, the processor 402 may include one or more processing units (e.g., in a multi-core configuration) for executing the instructions. The instructions may be executed within a variety of different operating systems on the open banking installment offer system 116, such as UNIX, LINUX, Microsoft Windows®, etc. More specifically, the instructions may cause various data manipulations on data stored in a storage device 414 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C #, C++, Java, or other suitable programming languages, etc.).

The processor 402 may be operatively coupled to a communication interface 410 such that the open banking installment offer system 116 can communicate with a remote device such as a user computing system 200 (shown in FIG. 2), one or more of the computers or systems 104, 106, 110, 112, 116, 122, 126, and 128, and/or another server system. For example, the communication interface 410 may receive communications from a consumer computing device 104 via the Internet (FIG. 1) and/or one or more merchant computers 106 via the network 114.

The processor 402 may be operatively coupled to the storage device 414. The storage device 414 may be any computer-operated hardware suitable for storing and/or retrieving data. In some embodiments, the storage device 414 may be integrated in the open banking installment offer system 116. In other embodiments, the storage device 414 may be external to the open banking installment offer system 116. The storage device may be similar to and/or include the database 118 (shown in FIG. 1). For example, the open banking installment offer system 116 may include one or more hard disk drives as the storage device 414. In other embodiments, the storage device 414 may be external to the open banking installment offer system 116 and may be accessed by a plurality of server systems 300 and/or open banking installment offer systems. For example, the storage device 414 may include multiple storage units such as hard disks or solid-state disks in a redundant array of inexpensive disks (RAID) configuration. The storage device 414 may include a storage area network (SAN) and/or a network attached storage (NAS) system.

In some embodiments, the processor 402 may be operatively coupled to the storage device 414 via a storage interface 412. The storage interface 412 may be any component capable of providing the processor 402 with access to the storage device 414. The storage interface 412 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 414.

The memory 404 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In an embodiment, the account module 406 may receive account registration data and/or account access data from a consumer, such as the consumer 102. In addition, the account module 406 may retrieve financial and/or transaction related data from a database, such as the database 118 (shown in FIG. 1). The open banking module 408 may retrieve one or more BNPL installment loan offers 124 (i.e., a personalized list of BNPL installment offers) (shown in FIG. 1) from the IPPs 126, 128, and/or merchant 108, and present the offers to the consumer, at the consumer computing device 104. In addition, the open banking module 408 may transmit the financial and/or transaction related data to the IPPs 126, 128, based on a selection of one of the IPPs by the consumer 102. While the account module 406 and the open banking module 408 are depicted as being executed on a single computing system, such as the open banking installment offer system 116 shown in FIG. 4, it should be appreciated that in some embodiments, the open banking installment offer system 116 may include a first computing device configured to execute the account module 406 and a second computing device configured to execute the open banking module 408.

### Computer-Implemented Methods

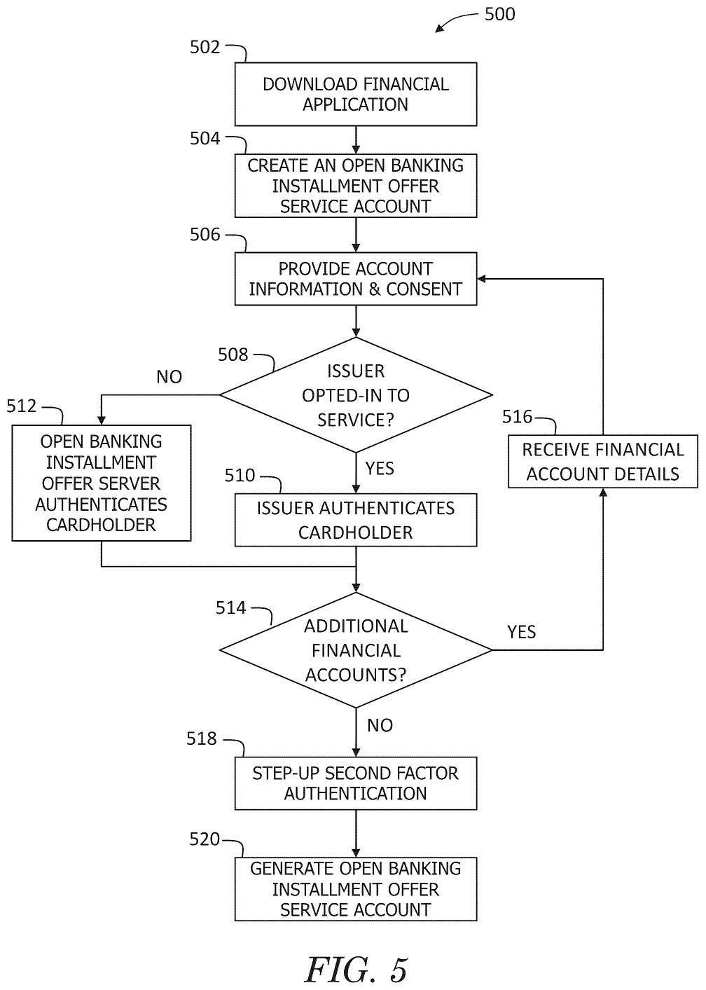

FIG. 5 is a flowchart illustrating an exemplary computer-implemented method 500 for registering a consumer, such as the consumer 102, for an open banking installment offer service, in accordance with embodiments of the present disclosure. The operations described herein may be performed in the order shown in FIG. 5 or may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1-4 and 7. In one embodiment, the method 500 may be implemented by the payment network 112 (shown in FIG. 1). In another embodiment, the method 500 may be implemented by a third-party open banking provider 132 (shown in FIG. 7), wherein the open banking provider 132 is substituted for the payment network 112 and open banking installment offer system 116 in the following discussion. In an embodiment, the method 500 generally concerns receiving consumer registration data or information from the consumer computing device 104 (shown in FIG. 1) upon registration for the open banking installment offer service. While operations within the method 500 are described below regarding the consumer computing device 104, the method 500 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

Referring to operation 502, in the example embodiment, the consumer 102 may download the financial application 120 (shown in FIG. 1). For example, the consumer 102 may connect to the payment network 112, which may instruct the consumer 102 to download the financial application 120 to the consumer computing device 104 for direct communication with the open banking installment offer system 116 via the payment network 112, e.g., without use of a web browser. When the consumer 102 uses the financial application 120, a direct link may be established via a wireless connection, for example, via a Wi-Fi connection to the network 114. The consumer computing device 104, such as a web-based smartphone, may be configured to execute for display the financial application 120. In some embodiments, the financial application 120 may be stored in a cloud-based interface, which may include cloud storage capability as well as any cloud-based application programming interface (API) that facilitates communication between the consumer computing device 104 and open banking installment offer system 116. The financial application 120 may facilitate transmitting and receiving data between the consumer computing device 104 and the payment network 112 to enroll the consumer 102 and receive cardholder consent for access to one or more of his or her financial accounts via the open banking infrastructure.

At operation 504, the consumer 102 may be presented, by the account module 406, with an option to create an open banking installment offer service account. For example, the consumer 102 may enroll for the open banking installment offer service via the financial application 120 or via a suitable webpage of the payment network 112 using, for example, the consumer computer device 104. The consumer 102 may enroll or register with the open banking installment offer service in any of several ways, including utilizing the consumer computer device 104 to access the payment network 112 via the Internet and providing required information. During consumer enrollment, the consumer 102 may provide account registration or enrollment data including basic information about himself or herself (e.g., name, address, phone number, email address, etc.) and, in some embodiments, provide information regarding the customer's computing devices (for example, by providing a SIM identifier, a mobile telephone number, and/or other device identifier).

It is noted that the open banking installment offer service account may be linked to other Mastercard services, such as if the consumer 102 is already signed up for one or more other Mastercard services. In some embodiments, the information obtained from the consumer 102 during the enrollment process may include product and/or service preferences, and/or other information.

At operation 506, the consumer 102 may also provide, to the account module 406, information concerning his or her financial accounts including consent to access such accounts. For example, the consumer 102, via the consumer computer device 104, may be presented with a consent screen to provide consumer consent and to agree to any presented terms and conditions of the consent. In an example, the financial application 120 or webpage may integrate a user consent widget, lightbox, web-redirect, iframe, or the like, in the financial application 120 or webpage to allow the consumer 102 to provide his or her consent. Upon receipt of the consumer's consent, the consumer 102 may be presented an input screen to enter and submit the consumer financial account details associated with the account(s) to which the consumer 102 granted access for retrieving financial account data. The financial account details may include the payment card 103 (e.g., a bank credit card account, a debit card account, and/or a prepaid card issued to or held by him or her), including the bank identification number (BIN) associated with the consumer's financial account or payment card 103.

At operation 508, the payment network 112 may determine whether the issuer 122 of the payment card 103 and/or financial account has opted-in to the open banking installment offer service. If the issuer 122 has chosen to opt-in to the open banking installment offer service, at operation 510 the issuer 122 may authenticate the consumer 102 in real-time. For example, and without limitation, the issuer 122 may authenticate the consumer 102 via a one-time code sent to the consumer 102 via Short Message Service (SMS), e-mail, through an issuer mobile application, through a call center communication, and the like. In the exemplary embodiment, issuer authentication may be the preferred method for authenticating the consumer 102, as the issuer 122 and the consumer 102 have a direct relationship.

If the issuer 122 has not chosen to opt-in to the open banking installment offer service and therefore does not participate in the enrollment process, at operation 512, the payment network 112 may authenticate the consumer 102. For example, and without limitation, the consumer 102 may be asked to input a string of characters indicating a code printed on the signature panel of the consumer's payment card 103. For example, the signature panel code may be a card verification code (CVC) value. The values entered by the consumer 102 may be used by the payment network 112 to authenticate the consumer 102 prior to setting up the open banking installment offer service account and associating the consumer 102 and the payment card 103 with the account. For example, the payment network 112 may compare the entered values to the values associated with the payment card stored in a database (e.g., the database 118 shown in FIG. 1). If the entered values match the stored values, the consumer 102 may be authenticated. While this method allows the consumer 102 to be authenticated, it may not be as strong of an authentication or verification as provided by the issuer 122.

Optionally, the method 500 may include an additional operation for authenticating the consumer 102 offline. For example, and without limitation, the payment network 112 may provide an offline PIN (personal identification number) to the consumer 102 via mail.

At operation 514, the payment network 112, via the account module 406, may ask the consumer 102 whether the consumer has additional financial accounts or payment cards he or she wishes to associate with the consumer's open banking installment offer service account. If the consumer has additional payment cards to enter, at operation 516, the payment network 112 may receive the payment card details from the consumer 102 and return to operation 506. If the consumer does not have any additional payment cards to enter, the method may continue to operation 518.

At operation 518, the account module 406 of the payment network 112 may request that the consumer 102 set up a step-up authentication method, i.e., two-factor authentication. The additional authentication measures may be taken before a transaction may be entered into the open banking installment offer service. For example, and without limitation, in one embodiment, the consumer 102 may be requested to establish account access credentials, e.g., to select a username and password or PIN to be used for security purposes, and/or for use by the consumer 102 to login and change one or more preference and/or requirement settings. In addition to the password or PIN, the consumer 102 may be requested to set up a second authentication factor, including, for example, and without limitation, providing a biometric sample that is to be associated with the other registration information provided.

Biometric samples may include, without limitation, a fingerprint image, a voice recording, a retinal image, facial recognition, palm print image, iris recognition, and the like. The biometric sample may be unique to the consumer 102 and difficult to duplicate and/or forge by an unauthorized user. The biometric sample may be stored and associated with a biometric identifier, for example, by the payment network 112 (e.g., in the database 118). Additionally, the biometric identifier may be associated with the stored registration information and may facilitate secure authorization of information input by the consumer 102. A biometric input device in communication with the consumer computing device 104 may be used for the consumer 102 to enter the biometric sample. For example, the consumer computing device 104 may include an integral fingerprint or palm reader/scanner, retinal or iris reader/scanner, and/or voice reader/recorder.

In other suitable embodiments, the second factor may include, for example, and without limitation, SMS two-factor authentication (where a one-time use short code in sent to the consumer's mobile device via SMS), Time-Based One Time Password (TOTP) authentication (where an authenticator application provides a short code as a second factor), push-based two-factor authentication (where a prompt is sent to the consumer's mobile device), or any other two-factor authentication method that enables the method 500 to operate as described herein.

At operation 520, the account module 406 may generate the open banking installment offer service account or profile for the consumer 102, associating the consumer's financial accounts and/or payment card 103 (and any additionally added accounts and payment cards) with the consumer's profile, along with the consumer's account access credentials and any account preferences. The account preferences may include selection of one or more of the associated bank accounts for use with the open banking installment offer service. For example, the consumer 102 may provide account details for a plurality of accounts but only select a subset of those accounts for providing installment offers.

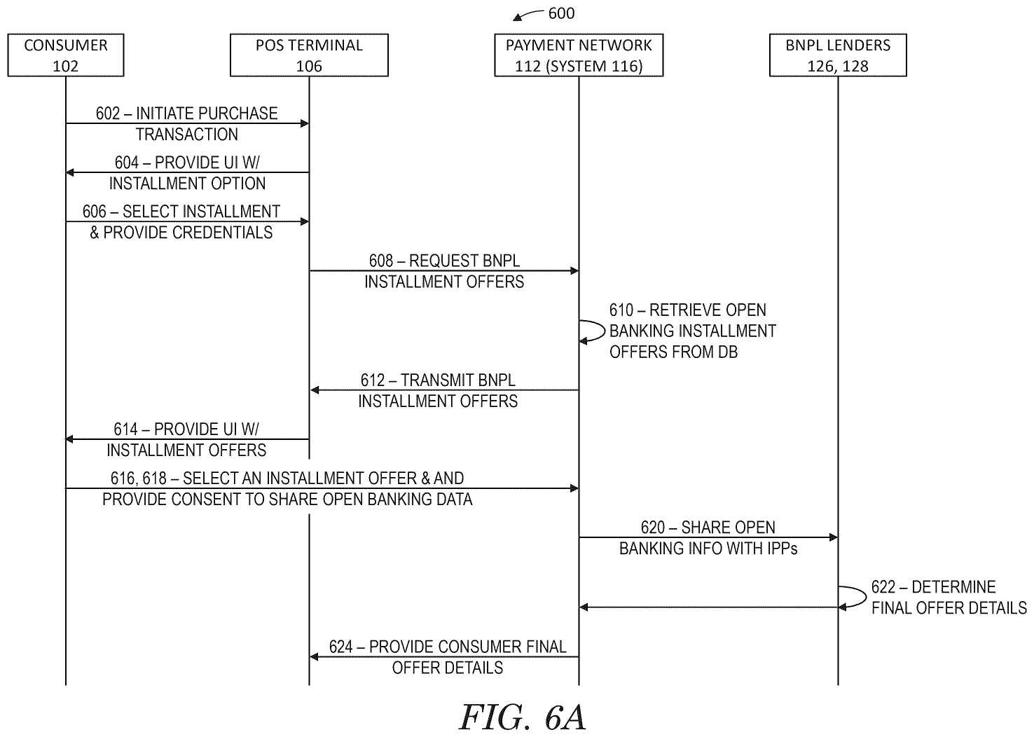

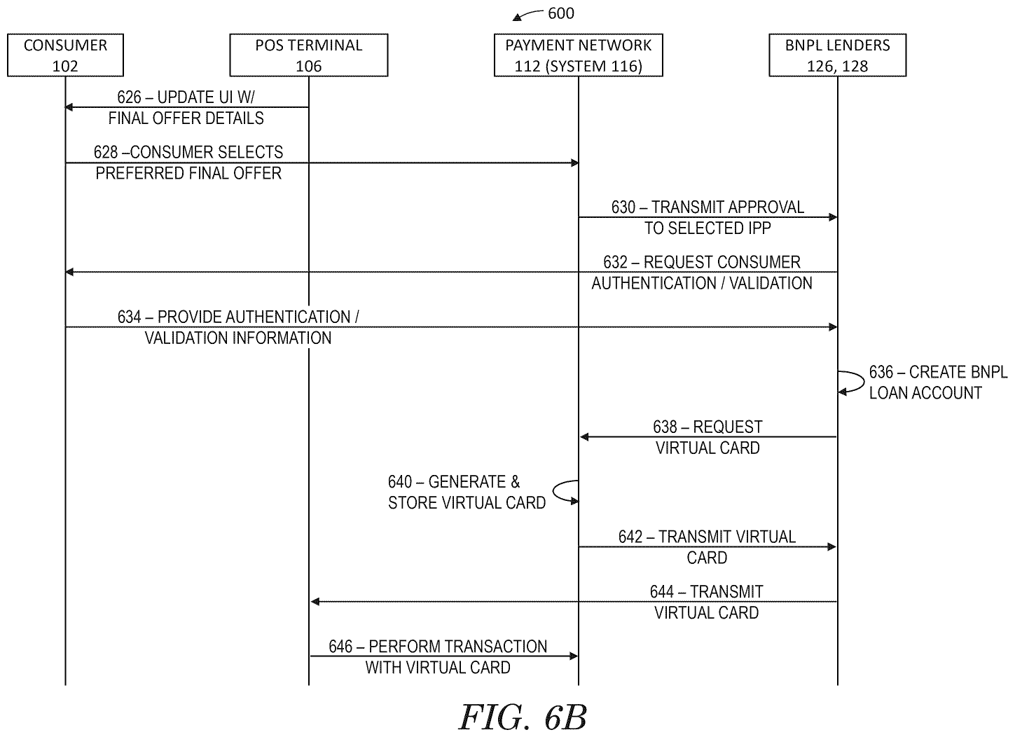

FIGS. 6A and 6B depict a flowchart illustrating an exemplary computer-implemented method 600 for completing a transaction with an open banking Buy Now, Pay Later (BNPL) installment offer made available to a consumer, such as the consumer 102, in accordance with embodiments of the present disclosure. The operations described herein may be performed in the order shown in FIGS. 6A and 6B or may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1-4. In one embodiment, the method 600 may be implemented by the payment network 112 (shown in FIG. 1), and more particularly, by the open banking installment offer system 116. In the exemplary embodiment, the method 600 executes a transaction of a consumer using a selected open banking BNPL installment loan offer that is made available to a consumer via open banking. While operations within the method 600 are described below regarding the open banking installment offer system 116, the method 600 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the exemplary embodiment, at operation 602, the consumer 102 may select one or more items to purchase from a merchant, such as the merchant 108 (shown in FIG. 1). As described herein, the merchant 108 may include a physical location and/or a virtual location. In an embodiment, if the transaction is being performed online, for example, at a merchant's virtual location, the consumer 102 may add the items to his or her checkout cart on the merchant's website or online application. The transaction may be initiated, for example, at the consumer computing device 104. Alternatively, the consumer 102 may select one or more items for purchase from a merchant storefront and present the items for checkout at the merchant computer 106 (e.g., a smart POI system). It is understood, however, that the transaction may be initiated at any computing device and/or merchant location configured to perform a purchase transaction on behalf of the merchant, such as the merchant 108.

During checkout, at operation 604, the consumer 102 may be presented with several payment options, including an option to use an installment loan. For example, the smart POI system 106 may present a selection of payments options and may prompt the consumer 102 to choose one of the payment options. In addition to traditional payment methods (e.g., cash, debit card, credit card, etc.), an option to pay by installments may be presented as an alternative. The selection of payments options may be presented to the consumer via a merchant checkout user interface (UI) displayed on a display of the consumer computing device 104, smart POI system 106, or other data processing device being used to perform the transaction.

At operation 606, the consumer 102 selects to pay for the transaction using a BNPL installment loan. Upon selection of the installment pay option (i.e., pay with a BNPL installment loan), the consumer 102 may be requested to provide his or her account access credentials to his or her open banking installment offer service account or profile. If the consumer does not have an open banking installment offer service account or profile, he or she may be requested to register for one to avail himself or herself to the open banking installment offer service features (see the method 500 shown in FIG. 5).

At step 608, the smart POI system 106 may retrieve one or more Buy Now, Pay Later (BNPL) installment offers from the payment network 112. For example, the smart POI system 106 may transmit a request message for one or more BNPL installment offers. The request message includes a request for the installment offer, transaction details associated with the transaction, and the consumer's account credentials. The request message is transmitted to the payment network 112, and more particularly, to the open banking installment offer system 116. The merchant 108 generally must integrate with the payment network 112 in order to retrieve and provide BNPL installment offers to its customers, such as consumer 102. This integration typically involves setting up a connection between the smart POI system 106 and the payment network's API (Application Programming Interface). In the exemplary embodiment, the payment network 112 may also operate as a BNPL provider interface, wherein various BNPL providers or lenders offering BNPL services provide various offers to the payment network 112 for distribution to various merchants, such as the merchant 108.

At operation 610, the open banking installment offer system 116, using the account module 406, may validate the consumer's account credentials and access the consumer's account. Using the open banking module 408, the open banking installment offer system 116 may retrieve one or more BNPL installment offers 124 (i.e., a personalized list of BNPL installment offers) (shown in FIG. 1) from the IPPs 126, 128 based on the consumer's account preferences and the transaction details. As discussed herein, the account preferences may include selection of one or more of the consumer's associated accounts for use with the open banking installment offer service. For example, the consumer 102 may provide account details for a plurality of bank accounts, but only select a subset of those accounts for providing installment offers.

At operation 612, the open banking module 408 may provide the one or more BNPL installment offers 124 to the smart POI system 106. The one or more BNPL installment offers 124 may include one or more bank offerings provided by the consumer's banks connected to the consumer account via open banking. In this manner, the consumer may receive BNPL installment offers from his or her banks with which he or she already has an established relationship. Furthermore, the one or more BNPL installment offers 124 may be available from the merchant 108 and one or more IPPs, such as the IPPs 126, 128, that are not associated with the consumer 102.

At operation 614, the smart POI system 106 may present the one or more BNPL installment offers 124 to the consumer 102, for example, via the merchant computer 106 and/or the consumer computing device 104. In some embodiments, each respective one or more BNPL installment offers 124 may include a visual and/or an audio machine-readable code. For example, respective BNPL installment offers may include, without limitation, a one-dimensional (1D) barcode or a two-dimensional (2D) barcode (e.g., a matrix barcode). A 1D barcode uses a series of variable-width lines and spaces to encode data. A 2D barcode uses patterns of squares, hexagons, dots, and other shapes to encode data. A 2D barcode may include, for example, and without limitation, a QR code or other codes such as a Data Matrix code, a PDF417 code, an EZcode, a high-capacity color barcode, a ShotCode, a MaxiCode, and the like.

At operation 616, the consumer 102 may select one of the presented BNPL installment loan offers 124. For example, in one embodiment, the consumer computing device 104 may be used to interact with a machine-readable code feature presented to the consumer in association with the BNPL installment offers. The machine-readable code may be captured with a camera, a microphone, radio receiver, or other capture capability provided by the consumer computing device 104.

Upon the selection, at operation 618, the consumer 102 may be requested to provide consent for sharing his or her open banking data associated with the consumer's open banking installment offer service account or profile. As discussed above the payment network 112 may already have consumer consent to access various accounts associated with the consumer via open banking. The consumer may additionally consent to share such account information with the IPPs associated with the one or more BNPL installment loan offers 124. In an example, the consumer 102 may be presented, via the consumer computer device 104, with a consent screen to provide consumer consent and to agree to any presented terms and conditions of the consent. In an example, the consumer 102 may provide his or her consent to share the account data by clicking a checkbox on a screen of the smart POI system 106 or the consumer computing device 104. As such, the open banking module 408 of the open banking installment offer system 116 may receive a consent message from the smart POI system 106 or the consumer computing device 104. The consent message may include, for example, one or more data fields including consumer consent information indicating consent to share the consumer's open banking data.

Upon receiving the consent message from the consumer computing device 104, at operation 620, the open banking module 408 of the open banking installment offer system 116 may share the consumer's open banking (financial) data and the transaction details with each of the IPPs, such as the IPPs 126, 128, associated with at least one of the BNPL installment loan offers 124. The open banking data may include, for each open banking account associated with the consumer's open banking installment offer service account or profile, know your customer (KYC) data, transaction data, account details, and/or a credit rating or credit score for the consumer 102. KYC is a due diligence process used to verify the identity of the consumer 102 and that the data he or she has shared is correct (e.g., name, phone number, email, address, etc.). The open banking infrastructure is interlinked with credit score providers, so the consumer's credit rating/score is available via open banking. In addition, open banking enables IPPs, such as the IPPs 126, 128, to access and use a consumer's financial data, via consumer consent, to open new accounts, secure loans or lines of credit, etc. The transaction details may include, for example, a transaction amount, merchant data, and the like.

At operation 622, each IPP may determine its final BNPL installment loan offer 130 it is willing to offer the consumer 102 based on the shared open banking data and the transaction details. For example, and without limitation, each IPP may use the KYC data, transaction data and details, accounts details, and credit rating or credit score to determine its respective final offer. Each final BNPL installment offer 130 may include, for example, an interest rate, installment frequency, installment schedule, any fees, and the like. Each final BNPL installment loan offer 130 is transmitted back to the payment network 112, and more particularly, to the open banking installment offer system 116.

At operation 624, the open banking installment offer system 116 may provide one or more final BNPL installment offers 130 (i.e., final, personalized list of BNPL installment offers) (shown in FIG. 1) to the smart POI system 106. The one or more final BNPL installment offers 130 may include one or more bank offerings provided by the consumer's banks connected to the consumer account via open banking. In this manner, the consumer may receive BNPL installment offers from his or her banks with which he or she already has an established relationship. Furthermore, the one or more final BNPL installment offers 130 may be available from the merchant 108 and one or more IPPs that are not associated with the consumer 102.

At operation 626, the smart POI system 106 may present the one or more final BNPL installment offers 130 to the consumer 102, for example, via the merchant computer 106 and/or the consumer computing device 104. The one or more final BNPL installment offers 130 may be presented, for example, by updating the previously presented offers with the final details provided by the open banking installment offer system 116. In some embodiments, each respective one or more final BNPL installment offers 130 may include a visual and/or an audio machine-readable code. For example, respective BNPL installment offers may include, without limitation, a one-dimensional (1D) barcode or a two-dimensional (2D) barcode (e.g., a matrix barcode), as discussed herein.

At operation 628, the consumer may select one of the presented final BNPL installment loan offers 130 as his or her preferred offer. For example, in one embodiment, the consumer computing device 104 may be used to interact with a machine-readable code feature presented to the consumer in association with the final BNPL installment offers. The machine-readable code may be captured with a camera, a microphone, radio receiver, or other capture capability provided by the consumer computing device 104. The consumer computing device may then transmit a selection response to the open banking installment offer system 116.

Upon the selection, at operation 630, the open banking installment offer system 116 may transmit an approval message to the selected IPP (e.g., IPP 126 or 128) granting approval to complete the BNPL installment loan process for completing the transaction, for example, by issuing the BNPL installment loan to the consumer 102.

At operation 632, the selected IPP may request authentication and validation information from the consumer 102. For example, using the KYC data consented to by the consumer 102, the selected IPP may contact the consumer 102 via a previously authenticated method (i.e., a method previously authenticated by one of the consumer's present financial institutions). In this manner, the sharing of the consented to open banking data allows the IPP to use the KYC data to authenticate and validate a new consumer.

At operation 634, the consumer 102 may provide the requested authentication and validation information to the selected IPP. This may include, for example, a response to a prompt on the consumer computing device 104. The response may include a biometric sample of the consumer 102 to authentic and validate the consumer.

At operation 636, the selected IPP may generate a BNPL installment loan account associated with the consumer 102 and the final terms of the BNPL installment loan. At operation 638, the selected IPP may request a single use virtual payment card from the payment network 112, for example, via the open banking installment offer system 116. The single use virtual payment card may be used to perform the transaction, wherein the virtual payment card may be associated with the consumer 102 and/or a consumer funding account. At operation 640, the payment network 112 may generate and store the single use virtual payment card (e.g., in the database 118), which may be associated with the selected IPP, the consumer, and/or the BNPL installment loan. In an example embodiment, the virtual payment card may be linked to a specific transaction (based on the BNPL installment loan request, for example) and/or may have a predefined credit limit based on the selected IPP's approval of the BNPL installment loan. The virtual payment card may be created, for example, by generating a primary account number (PAN) for the BNPL installment loan (referred to herein as a “BNPL PAN”) for the single use virtual payment card. The BNPL PAN may identify the network (e.g., the payment network 112) with which to send transaction messages and the selected IPP associated with issuing the BNPL installment loan. The virtual payment card may be tokenized in a similar manner as payment cards. In some examples, the payment network 112 may write the BNPL PAN and BNPL installment loan details associated with the single use virtual payment card to a record in the database 118. Accordingly, a query or data request associated with the single use virtual payment card (or credential) may return the details of the installment repayment arrangements that correspond to the single use virtual payment card (or credential).

At operation 642, the open banking installment offer system 116 may transmit the BNPL PAN and/or corresponding token to the selected IPP. The selected IPP may store the BNPL PAN and/or corresponding token in association with the BNPL installment loan account. Accordingly, when a transaction is performed using the BNPL PAN and/or corresponding token, the selected IPP may appropriately identify the associated funding account for the transaction.

At operation 644, the selected IPP may transmit the BNPL PAN and/or corresponding token to the smart POI system 106 for executing the transaction. At operation 646, the transaction may be executed as if the consumer 102 had used a traditional payment card. For example, the selected IPP may receive a payment authorization request message (including the BNPL PAN and transaction amount) from the smart POI system 106 (e.g., via the payment network 112) to execute the transaction using the BNPL PAN for the transaction amount. After approval of the transaction by the selected IPP, the merchant 108 may receive payment from the selected IPP for the full purchase amount.

### Example System With Third Party Open Banking Provider

FIG. 7 is a block diagram of an exemplary system 700 for providing one or more Buy Now, Pay Later (BNPL) financing products (e.g., BNPL installment loans) to a consumer 102 via open banking, in accordance with an aspect of the present invention. The system 700 is similar to the system 100 (shown in FIG. 1) discussed above, and as such, identical features have the same reference characters as above. In addition, for clarity, the description of such identical features will not be discussed again.

The system 700 includes a third-party open banking provider and associated computer 132 (the reference character 132 may be used herein in association with the open banking provider and the open banking computer). Computer-implemented operations described herein as being performed by the open banking provider 132 are understood to be performed by the open banking provider computer.

The open banking provider 132 may be configured to receive transaction data, financial account information, a credit rating or credit score, personal information, and/or location data associated with a consumer, such as the consumer 102. The transaction data may include, for example, a large sample of initial and/or historical transaction data. The financial account information may include a bank identification number (BIN) associated with the consumer's financial account or payment card 103. The BIN may allow the open banking provider 132 to identify BNPL installment offers available to the consumer 102 being offered by BNPL providers (such as the IPPs 126, 128) and/or merchants (such as the merchant 108) that may be associated with a specific BIN or BIN range. The personal information may include, for example, contact information (e.g., name, phone number, email address, etc.), demographic information (e.g., age, gender, marital status, income, education, employment, etc.), and the like. The credit rating or credit score may be associated with the consumer 102 identified by the personal information. Additionally, the location information may include location data identifying a physical or geographic location of the consumer computing device 104, which may generally be associated with the consumer 102.

The open banking provider 132 may also be configured to store lending preferences of a consumer, such as the consumer 102. The lending preferences may include, for example, one or more consumer preferred IPPs and/or loan preferences (e.g., loan length, APR, etc.). Loan preferences may include, for example, a loan length, an APR, etc.

The open banking provider 132 may also be configured to receive product data and BNPL installment loan offers from IPPs, such as the IPPs 126, 128. For example, a BNPL installment loan offer or program 124 may include a credit amount, a credit limit or value, an associated duration or installment period, an annual percentage rate (APR), a product SKU (shop-keeping unit) or SKUs associated with the BNPL installment loan offer, a date range specifying when the BNPL installment loan offer is valid, payment card BIN or BIN ranges, restrictions, and the like.

The open banking provider 132 may also be configured to receive product data and available BNPL installment offers from merchants, such as the merchant 108. For example, the merchant 108 may provide a product SKU or SKUs associated with any BNPL installment loan offers that the merchant 108 may offer to its customers, such as the consumer 102. For example, the merchant 108 may have a working relationship with one or more IPPs, such as the IPPs 126, 128, and may select to offer one or more BNPL installment loans from the IPPs 126, 128 to its customers.

### Computer-Implemented Method With Third Party Open Banking Provider

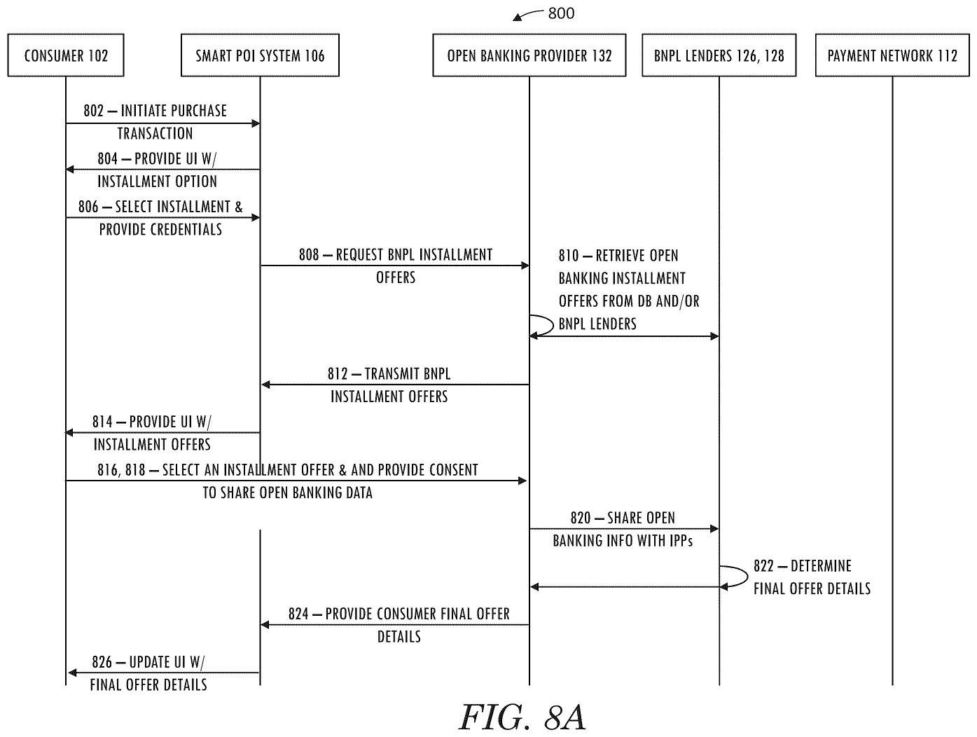

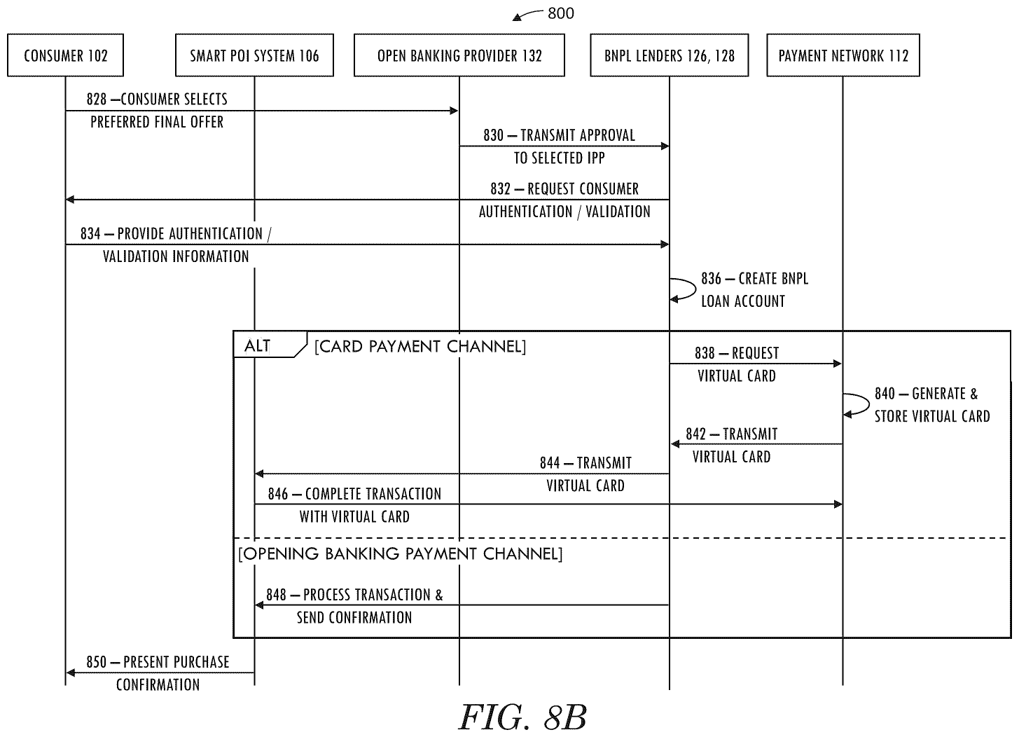

FIGS. 8A and 8B depict a flowchart illustrating an exemplary computer-implemented method 800 for completing a transaction with an open banking Buy Now, Pay Later (BNPL) installment offer made available to a consumer, such as the consumer 102, in accordance with embodiments of the present disclosure. The operations described herein may be performed in the order shown in FIGS. 8A and 8B or may be performed in a different order. Furthermore, some operations may be performed concurrently as opposed to sequentially. In addition, some operations may be optional.

The computer-implemented method 800 is described below, for ease of reference, as being executed by exemplary devices and components introduced with the embodiments illustrated in FIGS. 1-4 and &. In one embodiment, the method 800 may be implemented by the open banking provider 132, and more particularly, by the open banking provider computer. In the exemplary embodiment, the method 800 executes a transaction of a consumer using a selected open banking BNPL installment loan offer that is made available to a consumer via open banking. While operations within the method 800 are described below regarding the open banking provider 132, the method 600 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the exemplary embodiment, at operation 802, the consumer 102 may select one or more items to purchase from a merchant, such as the merchant 108 (shown in FIG. 1). As described herein, the merchant 108 may include a physical location and/or a virtual location. In an embodiment, if the transaction is being performed online, for example, at a merchant's virtual location, the consumer 102 may add the items to his or her checkout cart on the merchant's website. The transaction may be initiated at the consumer computing device 104. Alternatively, the consumer 102 may select one or more items for purchase from a merchant storefront and present the items for checkout at the merchant computer 106 (e.g., the smart POI system). It is understood, however, that the transaction may be initiated at any computing device and/or merchant location configured to perform a purchase transaction on behalf of the merchant, such as the merchant 108.

During checkout, at operation 804, the consumer 102 may be presented with several payment options, including an option to use an installment loan. For example, the smart POI system 106 may present a selection of payments options and may prompt the consumer 102 to choose one of the payment options. In addition to traditional payment methods (e.g., cash, debit card, credit card, etc.), an option to pay by installments may be presented as an alternative. The selection of payments options may be presented to the consumer via a merchant checkout user interface (UI) displayed on a display of the consumer computing device 104, smart POI system 106, or other data processing device being used to perform the transaction.

At operation 806, the consumer 102 may select to pay for the transaction using a BNPL installment loan. Upon selection of the installment pay option (i.e., pay with a BNPL installment loan), the consumer 102 may be requested to provide his or her account access credentials to his or her open banking installment offer service account or profile. If the consumer does not have an open banking installment offer service account or profile, he or she may be requested to register for one to avail himself or herself to the open banking installment offer service features (see the method 500 shown in FIG. 5).

At step 808, the smart POI system 106 may request one or more Buy Now, Pay Later (BNPL) installment offers from the open banking provider 132. For example, the smart POI system 106 may transmit a request message for one or more BNPL installment offers. The request message may include a request for the installment offer, transaction details associated with the transaction, and the consumer's account credentials. The request message may be transmitted to the open banking provider 132. The merchant 108 generally must integrate with the open banking provider 132 in order to retrieve and provide BNPL installment offers to its customers, such as the consumer 102. This integration typically involves setting up a connection between the smart POI system 106 and the open banking provider's API (Application Programming Interface).

At operation 810, the open banking provider 132, using the account module 406, may validate the consumer's account credentials, access the consumer's account, and retrieve one or more BNPL installment offers 124 (i.e., a personalized list of BNPL installment offers) (shown in FIG. 1) based on the consumer's account preferences and the transaction details. As discussed herein, the account preferences may include selection of one or more of the consumer's associated accounts for use with the open banking installment offer service. For example, the consumer 102 may provide account details for a plurality of bank accounts, but only select a subset of those accounts for providing installment offers.

At operation 812, the open banking module 408 may provide the one or more BNPL installment offers 124 to the smart POI system 106 for presenting to the consumer 102. The one or more BNPL installment offers 124 may include one or more bank offerings provided by the consumer's banks connected to the consumer account via open banking. In this manner, the consumer may receive BNPL installment offers from his or her banks with which he or she already has an established relationship. Furthermore, the one or more BNPL installment offers 124 may be available from the merchant 108 and one or more IPPs that are not associated with the consumer 102.

At operation 814, the smart POI system 106 may present the one or more BNPL installment offers 124 to the consumer 102, for example, via a display and/or the consumer computing device 104. In some embodiments, each respective one or more BNPL installment offers 124 may include a visual and/or an audio machine-readable code. For example, respective BNPL installment offers may include, without limitation, a one-dimensional (1D) barcode or a two-dimensional (2D) barcode (e.g., a matrix barcode). A 1D barcode uses a series of variable-width lines and spaces to encode data. A 2D barcode uses patterns of squares, hexagons, dots, and other shapes to encode data. A 2D barcode may include, for example, and without limitation, a QR code or other codes such as a Data Matrix code, a PDF417 code, an EZcode, a high-capacity color barcode, a ShotCode, a MaxiCode, and the like.

At operation 816, the consumer 102 may select one of the presented BNPL installment loan offers 124. For example, in one embodiment, the consumer computing device 104 may be used to interact with a machine-readable code feature presented to the consumer in association with the BNPL installment offers. The machine-readable code may be captured with a camera, a microphone, radio receiver, or other capture capability provided by the consumer computing device 104.

Upon the selection, at operation 818, the consumer 102 may be requested to provide consent to share his or her open banking data associated with the consumer's open banking installment offer service account or profile. As discussed above, the open banking provider 132 may already have consumer consent to access various accounts associated with the consumer via open banking. The consumer may additionally consent to share such account information with the IPPs associated with the one or more BNPL installment loan offers 124. In an example, the consumer 102 may be presented, via the consumer computer device 104, with a consent screen to provide consumer consent and to agree to any presented terms and conditions of the consent. In an example, the consumer 102 may provide his or her consent to share the account data by clicking a checkbox on a screen of the smart POI system 106 or the consumer computing device 104. As such, the open banking module 408 of the open banking provider 132 may receive a consent message from the smart POI system 106 or the consumer computing device 104. The consent message may include, for example, one or more data fields including consumer consent information indicating consent to share the consumer's open banking data.

Upon receiving the consent message from the consumer computing device 104, at operation 820, the open banking module 408 of the open banking provider 132 may share the consumer's open banking (financial) data and the transaction details with each of the IPPs, such as the IPPs 126, 128, associated with at least one of the BNPL installment loan offers 124. The open banking data may include, for each open banking account associated with the consumer's open banking installment offer service account or profile, know your customer (KYC) data, transaction data, account details, and/or a credit rating or credit score for the consumer 102. KYC is a due diligence process used to verify the identity of the consumer 102 and that the data he or she has shared is correct (e.g., name, phone number, email, address, etc.). The open banking infrastructure is interlinked with credit score providers, so the consumer's credit rating/score is available via open banking. In addition, open banking enables IPPs, such as the IPPs 126, 128, to access and use a consumer's financial data, via consumer consent, to open new accounts, secure loans or lines of credit, etc. The transaction details may include, for example, a transaction amount, merchant data, and the like.

At operation 822, each IPP may determine a final BNPL installment loan offer 130 it is willing to offer the consumer 102 based on the shared open banking data and the transaction details. For example, and without limitation, each IPP may use the KYC data, transaction data and details, accounts details, and credit rating or credit score to determine its respective final BNPL installment loan offer 130. Each final BNPL installment loan offer 130 may include, for example, an interest rate, installment frequency, installment schedule, any fees, and the like. Each final BNPL installment loan offer 130 may be transmitted back to the open banking provider 132.

At operation 824, the open banking provider 132 may provide one or more of the final BNPL installment offers 130 (i.e., final, personalized list of BNPL installment offers) (shown in FIG. 1) to the smart POI system 106. The one or more final BNPL installment offers 130 may include one or more bank offerings provided by the consumer's banks connected to the consumer account via open banking. In this manner, the consumer may receive BNPL installment offers from his or her banks with which he or she already has an established relationship. Furthermore, the one or more final BNPL installment offers 130 may be available from the merchant 108 and one or more IPPs that are not associated with the consumer 102.

At operation 826, the smart POI system 106 may present the one or more final BNPL installment offers 130 to the consumer 102, for example, via a display screen and/or the consumer computing device 104. The one or more final BNPL installment offers 130 may be presented, for example, by updating the previously presented offers with the final details provided by the open banking provider 132. In some embodiments, each respective one or more final BNPL installment offers 130 may include a visual and/or an audio machine-readable code. For example, respective BNPL installment offers may include, without limitation, a one-dimensional (1D) barcode or a two-dimensional (2D) barcode (e.g., a matrix barcode), as discussed herein.

At operation 828, the consumer may select one of the presented final BNPL installment loan offers 130 as his or her preferred offer. For example, in one embodiment, the consumer computing device 104 may be used to interact with a machine-readable code feature presented to the consumer in association with the final BNPL installment offers. The machine-readable code may be captured with a camera, a microphone, radio receiver, or other capture capability provided by the consumer computing device 104. The consumer computing device may then transmit a selection response to the open banking provider 132.

Upon the selection, at operation 830, the open banking provider 132 may transmit an approval message to the selected IPP (e.g., IPP 126 or 128) granting approval to complete the BNPL installment loan process for completing the transaction, for example, by issuing the BNPL installment loan to the consumer 102.

At operation 832, the selected IPP may request authentication and validation information from the consumer 102. For example, using the KYC data consented to by the consumer 102, the selected IPP may contact the consumer 102 via a previously authenticated method (i.e., a method previously authenticated by one of the consumer's present financial institutions). In this manner, the sharing of the consented to open banking data allows the IPP to use the KYC data to authenticate and validate a new consumer.

At operation 834, the consumer 102 may provide the requested authentication and validation information to the selected IPP. This may include, for example, a response to a prompt on the consumer computing device 104. The response may include a biometric sample of the consumer 102 to authentic and validate the consumer.

At operation 836, the selected IPP may generate a BNPL installment loan account associated with the consumer 102 and the final terms of the BNPL installment loan. The selected IPP may then process the transaction in several ways, including using a selected transaction processing process, such as via a traditional transaction card payment channel or via an open banking payment channel.

If the selected IPP selects to process the transaction via a traditional transaction card payment channel, at operation 838, the selected IPP may request a single use virtual payment card from the payment network 112. The single use virtual payment card may be used to perform the transaction, wherein the virtual payment card may be associated with the consumer 102 and/or a consumer funding account. At operation 840, the payment network 112 may generate and store the single use virtual payment card (e.g., in the database 118), which may be associated with the selected IPP, the consumer, and/or the BNPL installment loan. In an example embodiment, the virtual payment card may be linked to a specific transaction (based on the BNPL installment loan request, for example) and/or may have a predefined credit limit based on the selected IPP's approval of the BNPL installment loan. The virtual payment card may be created, for example, by generating a primary account number (PAN) for the BNPL installment loan (referred to herein as a “BNPL PAN”) for the single use virtual payment card. The BNPL PAN may identify the network (e.g., the payment network 112) with which to send transaction messages and the selected IPP associated with issuing the BNPL installment loan. The virtual payment card may be tokenized in a similar manner as payment cards. In some examples, the payment network 112 may write the BNPL PAN and BNPL installment loan details associated with the single use virtual payment card to a record in the database 118. Accordingly, a query or data request associated with the single use virtual payment card (or credential) may return the details of the installment repayment arrangements that correspond to the single use virtual payment card (or credential).

At operation 842, the payment network 112 may transmit the BNPL PAN and/or corresponding token to the selected IPP. The selected IPP may store the BNPL PAN and/or corresponding token in association with the BNPL installment loan account. Accordingly, when a transaction is performed using the BNPL PAN and/or corresponding token, the selected IPP may appropriately identify the associated funding account for the transaction.

At operation 844, the selected IPP may transmit the BNPL PAN and/or corresponding token to the smart POI system 106 for executing the transaction. At operation 846, the transaction may be executed via the payment network 112 using the BNPL PAN as if the consumer 102 had used a traditional payment card. For example, the selected IPP may receive a payment authorization request message (including the BNPL PAN and transaction amount) from the smart POI system 106 (e.g., via the payment network 112) to execute the transaction using the BNPL PAN for the transaction amount. After approval of the transaction by the selected IPP, the merchant 108 may receive payment from the selected IPP for the full purchase amount.

Alternatively, the selected IPP may select to process the transaction via an open banking payment channel. In this manner, at operation 848, the selected IPP and the merchant 108 (i.e., via the smart POI system 106) may communicate directly to process the transaction via a typical open banking transaction. For example, the selected IPP may transmit a payment instruction to the merchant 108 or merchant's bank (i.e., the acquirer 110). The selected IPP may debit the specified amount from the BNPL installment loan account associated with the consumer 102. The acquirer 110 may credit the merchant's account with the payment amount.

At operation 850, after processing of the transaction is completed, the smart POI system 106 may present a purchase confirmation to the consumer 102. For example, the smart POI system 106 may print a transaction receipt and/or transmit a digital record (or receipt) of the transaction to the consumer 102.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the phrases “payment card,” “payment device,” “transaction card,” “financial transaction card,” and the like refer to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A system comprising:
a database storing one or more installment loan offers and an open banking installment offer service account, the open banking installment offer service account being associated with account access credentials, open banking data associated with a consumer, and consumer preferences;
one or more processors coupled in communication to the database; and
a memory device storing computer-executable instructions thereon, the computer-executable instructions causing the one or more processors to:
receive, from a computer associated with a merchant, a request message for one or more installment loan offers, the request message being associated with a transaction being performed by the consumer, the request message including the account access credentials and transaction details associated with the transaction, the transaction details including a transaction amount;
validate the account access credentials;
access the open banking installment offer service account using the account access credentials;
retrieve, from the database, the one or more installment loan offers based on the consumer preferences;
transmit the one or more installment loan offers to the computer associated with the merchant; and
receive a consent message including consumer consent information indicating consent to share the open banking data with one or more installment program providers (IPPs).

2. The system in accordance with claim 1,
the computer-executable instructions further causing the one or more processors to:
transmit the open banking data to the one or more IPPs;
receive, from the one or more IPPs, one or more final installment loan offers, each respective final installment loan offer based on the open banking data;
transmit the one or more final installment loan offers to the computer associated with the merchant; and
receive a selection response from the consumer, the selection response including a selected installment loan offer of one of the one or more final installment loan offers, the selected installment loan offer being associated with a selected IPP of the one or more IPPs.

3. The system in accordance with claim 2,
the computer-executable instructions further causing the one or more processors to transmit an approval message to the selected IPP, the approval message granting approval to the selected IPP to issue an installment loan corresponding to the selected installment loan offer.

4. The system in accordance with claim 3,
the computer-executable instructions further causing the one or more processors to receive a request for a single use virtual payment card, the single use virtual payment card to be associated with the installment loan.

5. The system in accordance with claim 4,
the computer-executable instructions further causing the one or more processors to:
generate the single use virtual payment card;
store the single use virtual payment card in the database;
associate the single use virtual payment card with one or more of the following: the selected IPP, the installment loan, and the consumer; and
transmit the single use virtual payment card to the selected IPP.

6. The system in accordance with claim 5,
the computer-executable instructions further causing the one or more processors to receive a payment authorization request message from the computer associated with the merchant, the payment authorization request message including the single use virtual payment card and the transaction amount.

7. The system in accordance with claim 1, wherein the open banking data includes, for each bank account associated with the open banking installment offer service account, one or more of the following: know your customer (KYC) data, transaction data, account details, and a credit rating or credit score for the consumer.

8. A computer-implemented method comprising:
receiving, from a computer associated with a merchant, a request message for one or more installment loan offers, the request message being associated with a transaction being performed by a consumer, the request message including account access credentials associated with an open banking installment offer service account and transaction details associated with the transaction, the transaction details including a transaction amount;
validating the account access credentials;
accessing the open banking installment offer service account using the account access credentials;
retrieving, from a database, the one or more installment loan offers based on consumer preferences associated with the open banking installment offer service account;
transmitting the one or more installment loan offers to the computer associated with the merchant; and
receiving a consent message including consumer consent information indicating consent to share open banking data with one or more installment program providers (IPPs), the open banking data associated with the consumer.

9. The computer-implemented method in accordance with claim 8 further comprising:
transmitting the open banking data to the one or more IPPs;
receiving, from the one or more IPPs, one or more final installment loan offers, each respective final installment loan offer based on the open banking data;
transmitting the one or more final installment loan offers to the computer associated with the merchant; and
receiving a selection response from the consumer, the selection response including a selected installment loan offer of one of the one or more final installment loan offers, the selected installment loan offer being associated with a selected IPP of the one or more IPPs.

10. The computer-implemented method in accordance with claim 9 further comprising transmitting an approval message to the selected IPP, the approval message granting approval to the selected IPP to issue an installment loan corresponding to the selected installment loan offer.

11. The computer-implemented method in accordance with claim 10 further comprising receiving a request for a single use virtual payment card, the single use virtual payment card to be associated with the installment loan.

12. The computer-implemented method in accordance with claim 11 further comprising:
generating the single use virtual payment card;
storing the single use virtual payment card in the database;
associating the single use virtual payment card with one or more of the following: the selected IPP, the installment loan, and the consumer; and
transmitting the single use virtual payment card to the selected IPP.

13. The computer-implemented method in accordance with claim 12 further comprising receiving a payment authorization request message from the computer associated with the merchant, the payment authorization request message including the single use virtual payment card and the transaction amount.

14. The computer-implemented method in accordance with claim 8, wherein the open banking data includes, for each bank account associated with the open banking installment offer service account, one or more of the following: know your customer (KYC) data, transaction data, account details, and a credit rating or credit score for the consumer.

15. A non-transitory computer-readable storage medium having computer-executable instructions stored thereon, the computer-executable instructions, when executed by one or more processors, causing the one or more processors to:
receive, from a computer associated with a merchant, a request message for one or more installment loan offers, the request message being associated with a transaction being performed by a consumer, the request message including account access credentials associated with an open banking installment offer service account and transaction details associated with the transaction, the transaction details including a transaction amount;
validate the account access credentials;
access the open banking installment offer service account using the account access credentials;
retrieve, from a database, the one or more installment loan offers based on consumer preferences associated with the open banking installment offer service account;
transmit the one or more installment loan offers to the computer associated with the merchant; and
receive a consent message including consumer consent information indicating consent to share open banking data with one or more installment program providers (IPPs), the open banking data associated with the consumer.

16. The non-transitory computer-readable storage medium in accordance with claim 15,
the computer-executable instructions causing the one or more processors to:
transmit the open banking data to the one or more IPPs;
receive, from the one or more IPPs, one or more final installment loan offers, each respective final installment loan offer based on the open banking data;
transmit the one or more final installment loan offers to the computer associated with the merchant; and
receive a selection response from the consumer, the selection response including a selected installment loan offer of one of the one or more final installment loan offers, the selected installment loan offer being associated with a selected IPP of the one or more IPPs.

17. The non-transitory computer-readable storage medium in accordance with claim 16,
the computer-executable instructions further causing the one or more processors to transmit an approval message to the selected IPP, the approval message granting approval to the selected IPP to issue an installment loan corresponding to the selected installment loan offer.

18. The non-transitory computer-readable storage medium in accordance with claim 17,
the computer-executable instructions further causing the one or more processors to receive a request for a single use virtual payment card, the single use virtual payment card to be associated with the installment loan.

19. The non-transitory computer-readable storage medium in accordance with claim 18,
the computer-executable instructions further causing the one or more processors to:
generate the single use virtual payment card;
store the single use virtual payment card in the database;
associate the single use virtual payment card with one or more of the following: the selected IPP, the installment loan, and the consumer; and
transmit the single use virtual payment card to the selected IPP.

20. The non-transitory computer-readable storage medium in accordance with claim 19,
the computer-executable instructions further causing the one or more processors to receive a payment authorization request message from the computer associated with the merchant, the payment authorization request message including the single use virtual payment card and the transaction amount.
